(19) United States
(12) Patent Application Publication
(10) Pub. No.: US 2011/0020482 A1
(43) Pub. Date: Jan. 27, 2011

(54) APPARATUS FOR TRANSFERRING DOSES OF PLASTIC MATERIAL

(76) Inventors: Zeno Zuffa, Borgo Tossignano (IT); Giambattista Cavina, Faenza (IT); Fiorenzo Parrinello, Medicina (IT)

Correspondence Address: LAUBSCHER & LAUBSCHER, P.C., 1160 SPA ROAD, SUITE 2B, ANNAPOLIS, MD, 21403, US

(21) Appl. No.: 12/864,100

(22) PCT Filed: Jan. 21, 2009
(86) PCT No.: PCT/IB09/00088

§ 371 Date: Oct. 14, 2010

(30) Foreign Application Priority Data
Jan. 29, 2008 (IT) MO2008A000023

(51) Int. Cl. B29C 43/00

(52) U.S. Cl. 425/115

(57) ABSTRACT

An apparatus includes a transferring arrangement arranged for delivering doses of plastic material to a compression-molding device. The transferring arrangement includes a containing arrangement arranged for receiving the doses and a movement-promoting arrangement received in the containing arrangement and movable with respect to the containing arrangement for delivering the doses to the compression-molding device. The movement-promoting arrangement is made at least partially of a porous material.

The invention relates to an apparatus for transferring doses of plastic material.

Apparatuses are known for compression-moulding doses of plastic material comprising a forming carousel in a peripheral region of which there are associated forming moulds, the forming moulds comprising a mould cavity—i.e. a female half mould—and a punch—i.e. a male half mould that are movable in relation to one another.

Each mould cavity is arranged for receiving a dose of plastic material in pasty state when the mould cavity is distant from the punch. The mould cavity and the punch are moved towards one another so that the punch penetrates inside the mould cavity and interacts with the dose of plastic material to mould the dose of plastic material. Apparatuses are also known that supply the mould cavities with doses of plastic material in a pasty state.

The aforesaid apparatuses comprise cutting devices that cut the plastic material that exits a dispensing nozzle of an extruder to give rise to the doses. The cutting devices may comprise one or several cutting elements, and one or more contrasting elements that act as abutting means for the plastic material and prevent a cutting element, after separating a dose from, the plastic material that exits the dispensing nozzle, from removing the dose from a delivering zone.

Such apparatuses comprise a first carousel supporting a plurality of removing elements that remove the doses that the cutting devices have separated from the dispensing nozzle and a second carousel supporting a plurality of distributing elements that receive the doses of plastic material from the aforesaid removing elements and deliver the removing elements to the mould cavities.

The first carousel and the second carousel have coinciding rotating axes and are arranged so that the removing elements are positioned at a vertical height that is greater than that of the distributing elements and the distributing elements are positioned at a vertical height that is greater than that of the mould cavities.

The removing elements are fixed to a peripheral zone of the first carousel and move along a circular path.

The distributing elements are supported by movable arms associated with the second carousel and move along a closed-loop path, this closed-loop path comprising a portion coinciding with a part of the aforesaid circular path, a further portion coinciding with a part of the trajectory—which is also circular—defined by the mould cavities during rotation, and two connecting portions interposed between the aforesaid portion and the aforesaid further portion.

In operation, a removing element removes a dose of plastic material from the extruder and, subsequently, delivers the dose of plastic material to a corresponding distributing element whilst the removing and distributing elements are mutually superimposed and move along coinciding circular trajectory portions.

Still subsequently, whilst the removing element continues to travel along a circular trajectory, a movable arm moves the distributing element away from the removing element and makes the distributing element supply a mould cavity.

The distributing element delivers the dose of plastic material to the mould cavity whilst the distributing element is superimposed on the mould cavity and moves along a portion of circular trajectory defined by the mould cavity. The movable arm enables the distributing element and the mould cavity to interact for a time that is longer than that during which they would interact if the distributing element were fixed to a peripheral zone of the second carousel. This enables an interval of time to be provided that is of significant length during which the dose can move from the distributing element to the mould cavity.

In the apparatuses disclosed above, each distributing element comprises a tubular casing that has an upper opening, through which a dose coming from a removing element enters inside the tubular casing and a lower opening through which the dose passes from the tubular casing to a mould cavity.

A drawback of the apparatuses disclosed above consists of the fact that the dose of plastic material tends to stick to the inside walls of the tubular casing.

A further drawback is that, when the dose is transferred from the distributing element to the mould cavity, the distributing element and the mould cavity are separated from one another by a considerable distance. As a result, the dose, whilst it travels the aforesaid distance—dropping by the force of gravity or pushed by a pressurised fluid—has a certain tendency to deviate from a theoretically provided trajectory.

As a result, the dose may not be received correctly inside the mould cavity.

The theoretically provided trajectory depends, amongst other things, on the forces (for example centrifugal force and centripetal force) that develop through the effect of the movement speed of the distributing element.

As the doses have a diameter that is slightly less than an internal diameter of the aforesaid tubular casing, the longitudinal axis of each dose, also because of the action of the aforementioned forces, tends not to coincide with the longitudinal axis of the tubular casing. As a result, the dose can interact with a portion of an internal wall of the tubular casing and adhere to this portion.

Further, also if the transferring element manages to deliver the dose to the mould cavity, an external surface of the dose may be damaged due to an excessive rubbing against the internal wall of the tubular casing. This can lead to an object, which has been obtained by compression-moulding of the dose, that has poor aesthetic and/or structural properties.

An object of the invention is to improve apparatuses for transferring doses of plastic material.

Another object is to obtain an apparatus for transferring doses of plastic material in which the tendency of the doses to adhere to the conveying elements of the doses with which the apparatus is provided is noticeably limited.

A further object is to obtain an apparatus for transferring doses of plastic material that correctly deposits the doses inside mould cavities that are intended for receiving the doses.

According to the invention, an apparatus is provided comprising transferring means arranged for delivering doses of plastic material to a compression-moulding device, said transferring means comprising containing means arranged for receiving said doses, characterised in that said transferring means comprises movement-promoting means received in said containing means and movable with respect, to said containing means for delivering said doses to said compression-moulding device, said movement-promoting means being made at least partially of a porous material.

Owing to this aspect of the invention, it is possible to obtain an apparatus in which the doses are accompanied by the transferring means up to an upper edge, or even as far as the inside of mould cavities of the compression-moulding device, which enables the transfer of the doses to be simplified and positioning thereof inside the mould cavities to be improved.

In addition, as the movement-promoting means is made at least partially of porous material, a thermal conditioning fluid can flow through the pores of the aforesaid porous material so as to interact with the doses. The thermal conditioning fluid, for example a cooling fluid, thermally conditions (for example cools) the doses, in accordance with the needs of a technological process to which the doses are subjected. This enables the adhesion of the doses to the movement-promoting means to be reduced significantly. Further, the thermal conditioning fluid can form, between a wall of the movement-promoting means and the doses, a layer of fluid that promotes the flow of the doses in relation to the aforesaid wall. In particular, the aforesaid layer of fluid contributes to keeping the aforesaid wall clean and preventing particles of the plastic material that forms the doses from depositing on the aforesaid wall. The plastic material may comprise additives of various types, for example pigments, stabilisers and the like, that may significantly increase the formation of deposits of plastic material on the aforesaid wall, which makes the movement and the transfer of the doses difficult.

Using a porous material enables a simple and effective cooling system of the movement-promoting means to be obtained.

The invention can be better understood and implemented with reference to the attached drawings that illustrate some embodiments thereof by way of non-limiting example, in which:

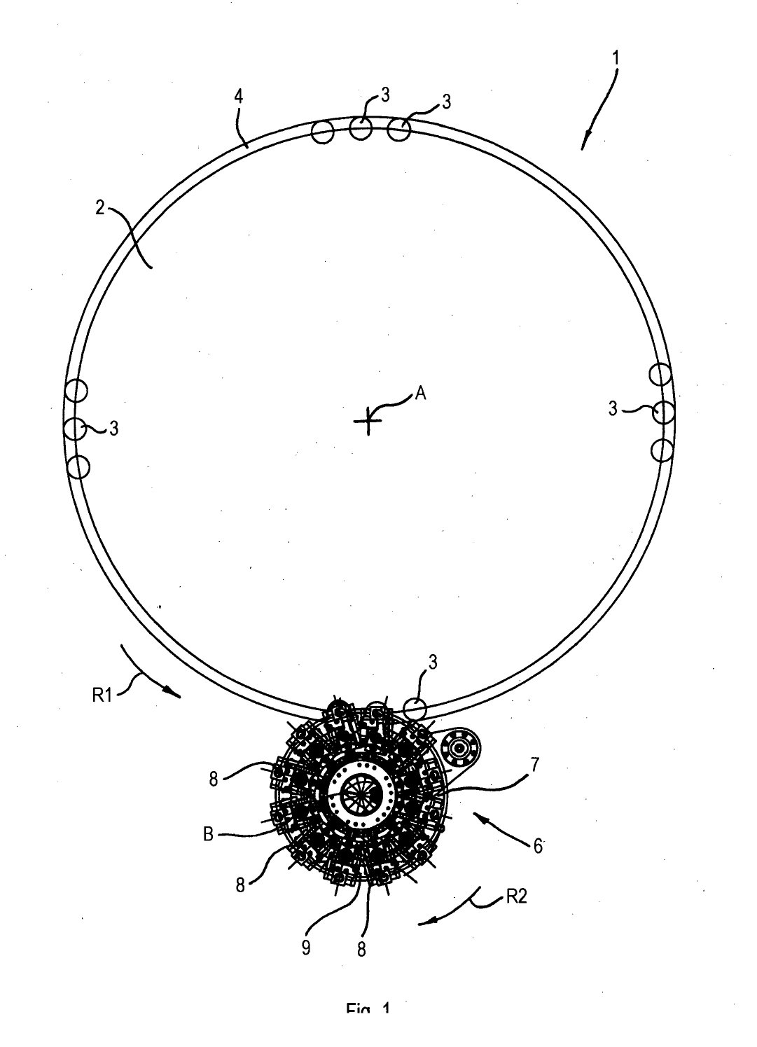

FIG. 1 is a plan view of an apparatus comprising a compression-moulding device and a device for transferring doses of plastic material;

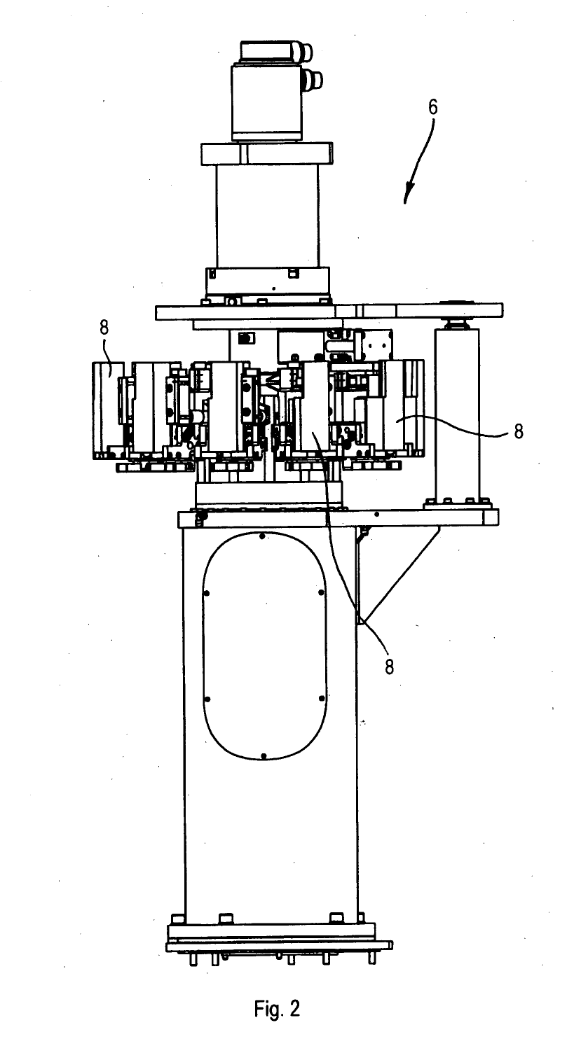

FIG. 2 is a side view of the device for transferring doses of plastic material of FIG. 1;

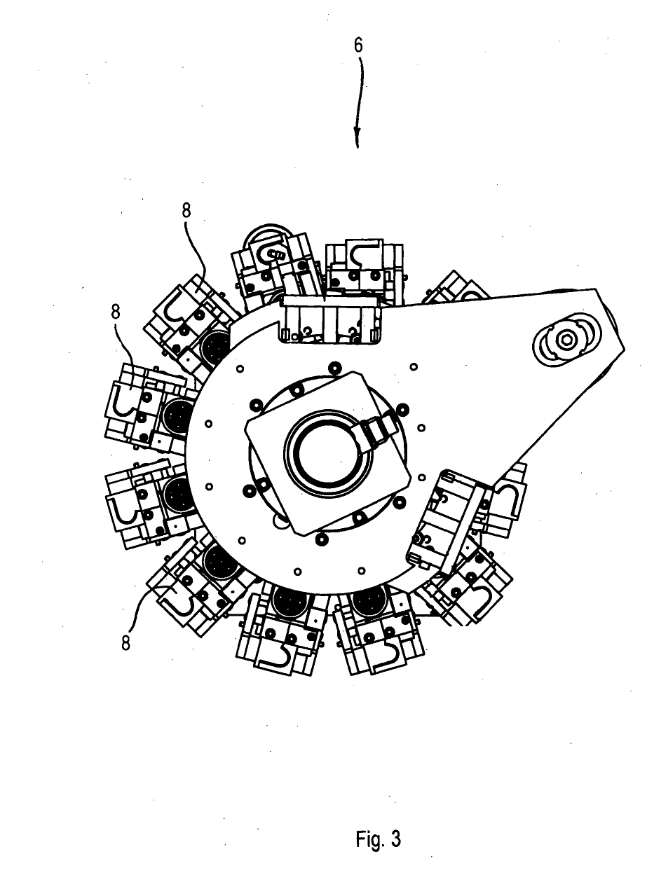

FIG. 3 is a plan view of the device for transferring doses of plastic material of FIG. 1;

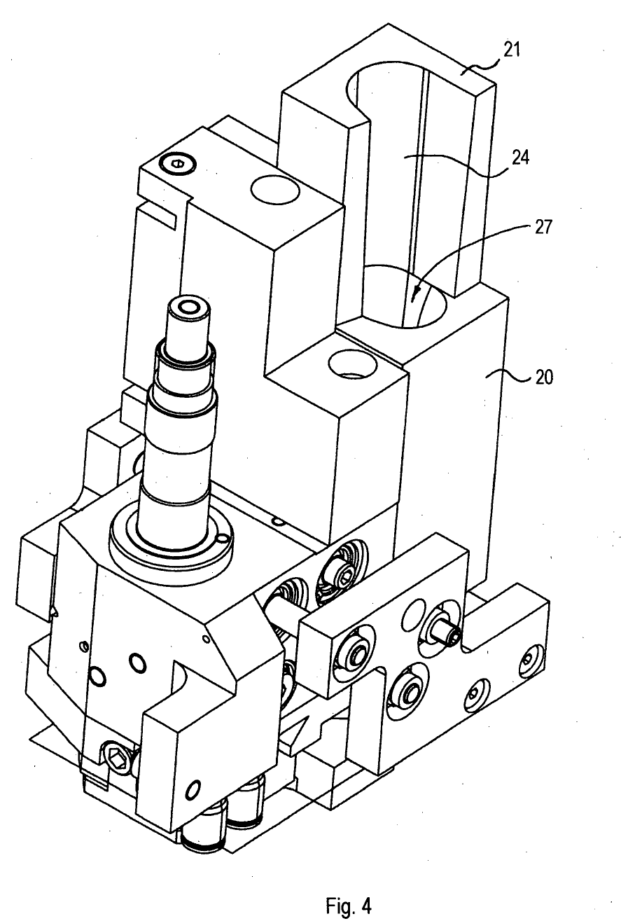

FIG. 4 is a partial perspective view of a conveying element for conveying the device for transferring doses of plastic material;

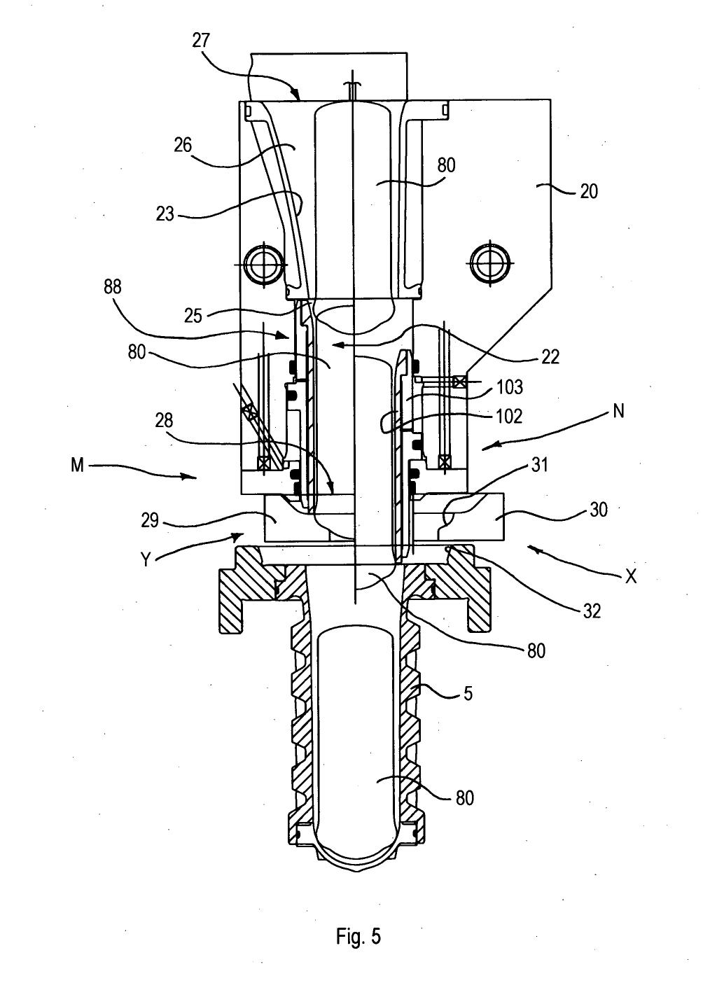

FIG. 5 is a section taken along a longitudinal plane of a first embodiment of a conveying element;

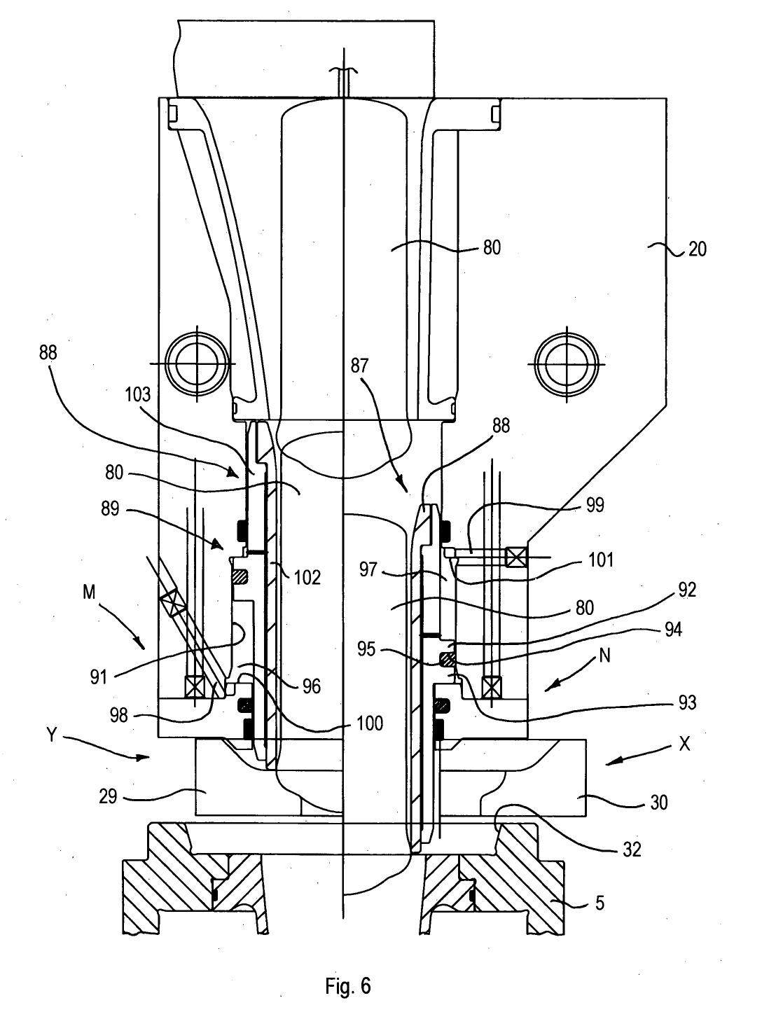

FIG. 6 is an enlarged detail of FIG. 5;

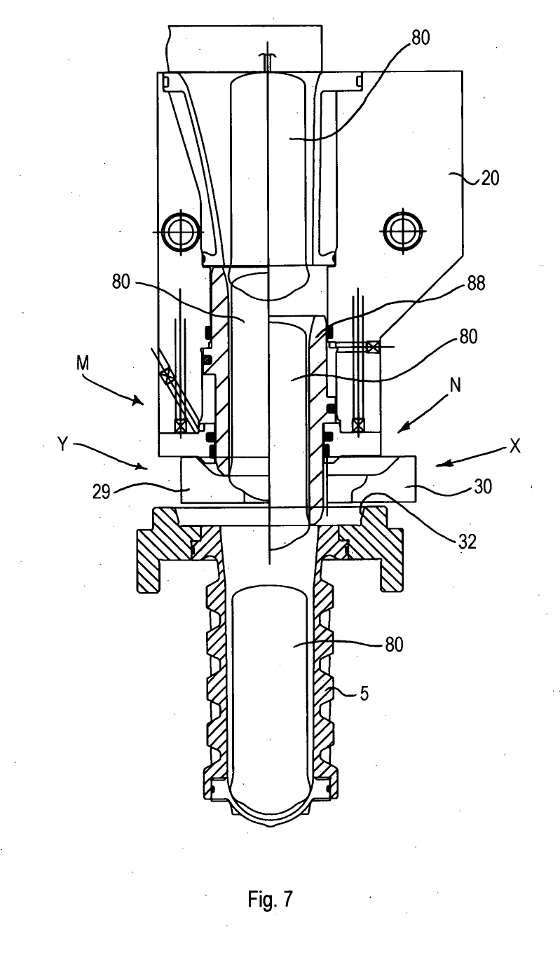

FIG. 7 is a section, like the one in FIG. 5 that shows a second embodiment of a conveying element;

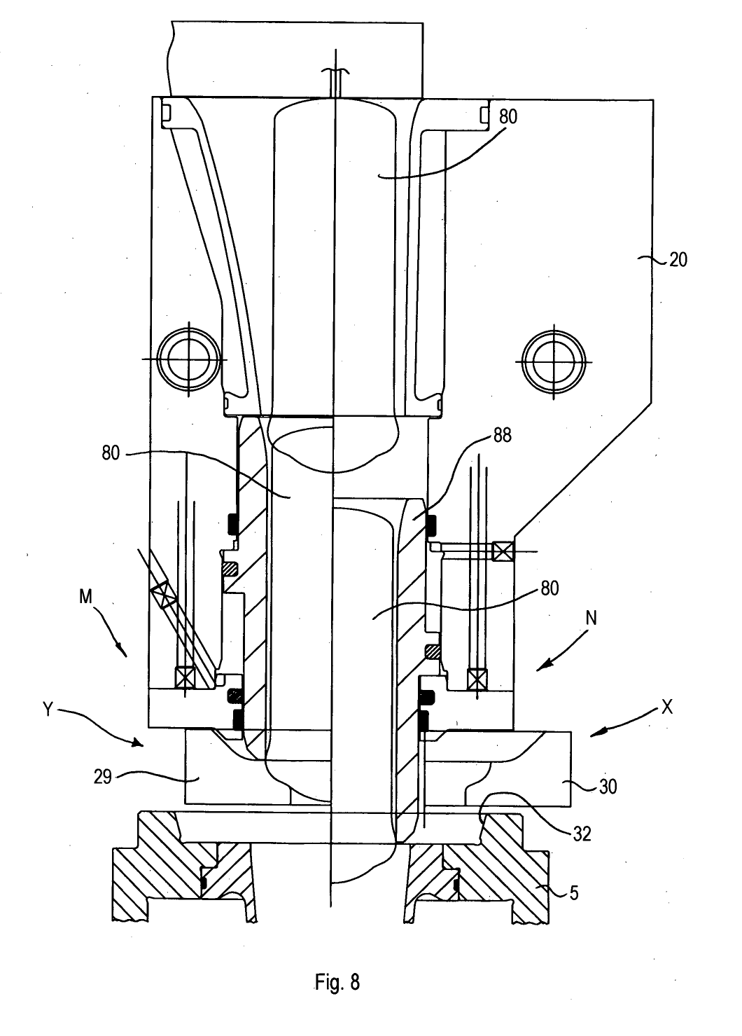

FIG. 8 is an enlarged detail of FIG. 7;

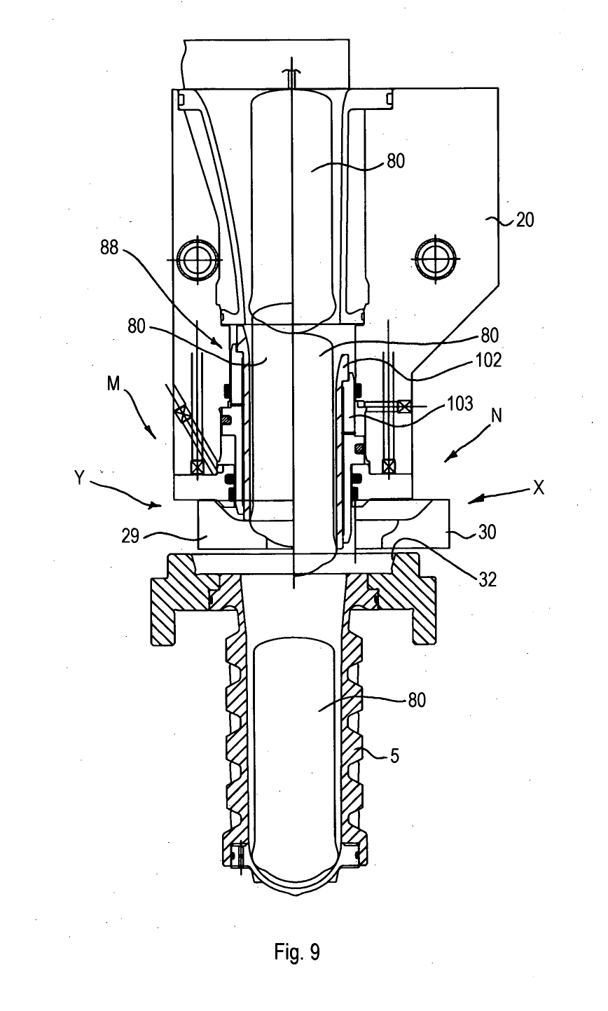

FIG. 9 is a section like the one in FIG. 5 that shows a third embodiment of a conveying element;

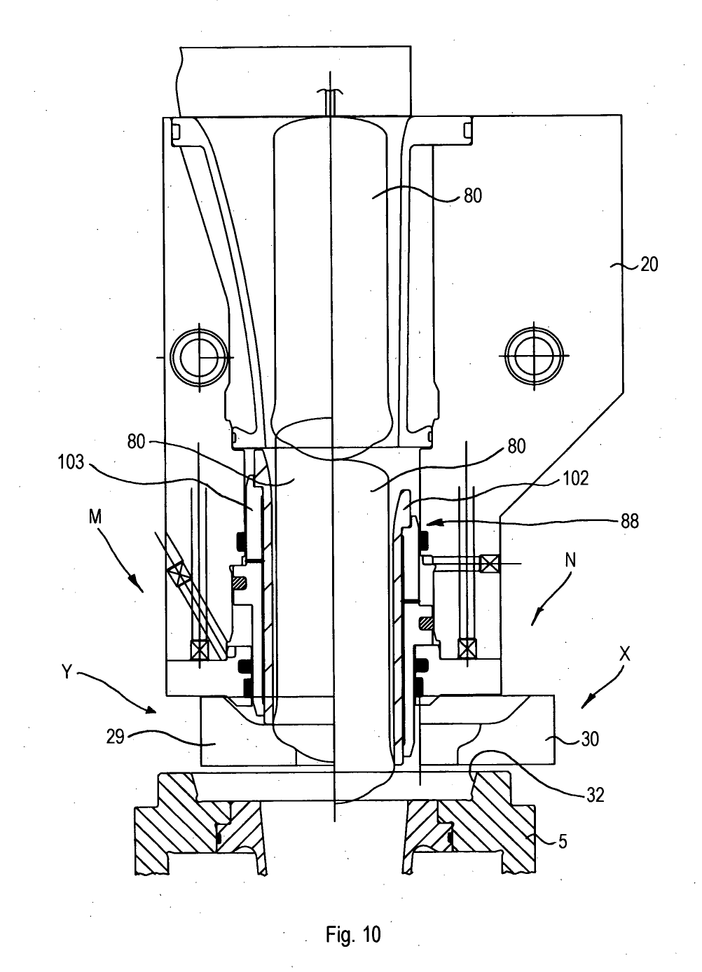

FIG. 10 is an enlarged detail of FIG. 9;

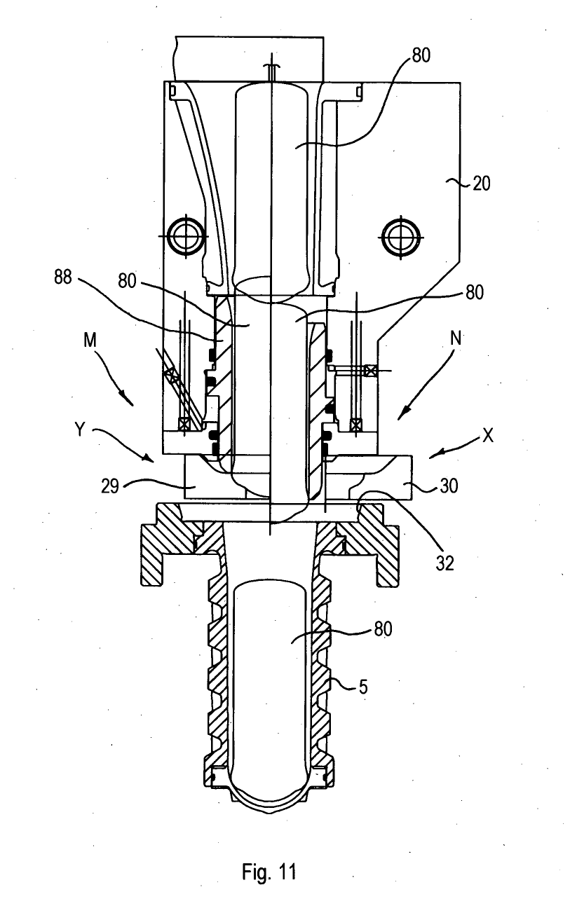

FIG. 11 is a section like the one in FIG. 5 that shows a fourth embodiment of a conveying element;

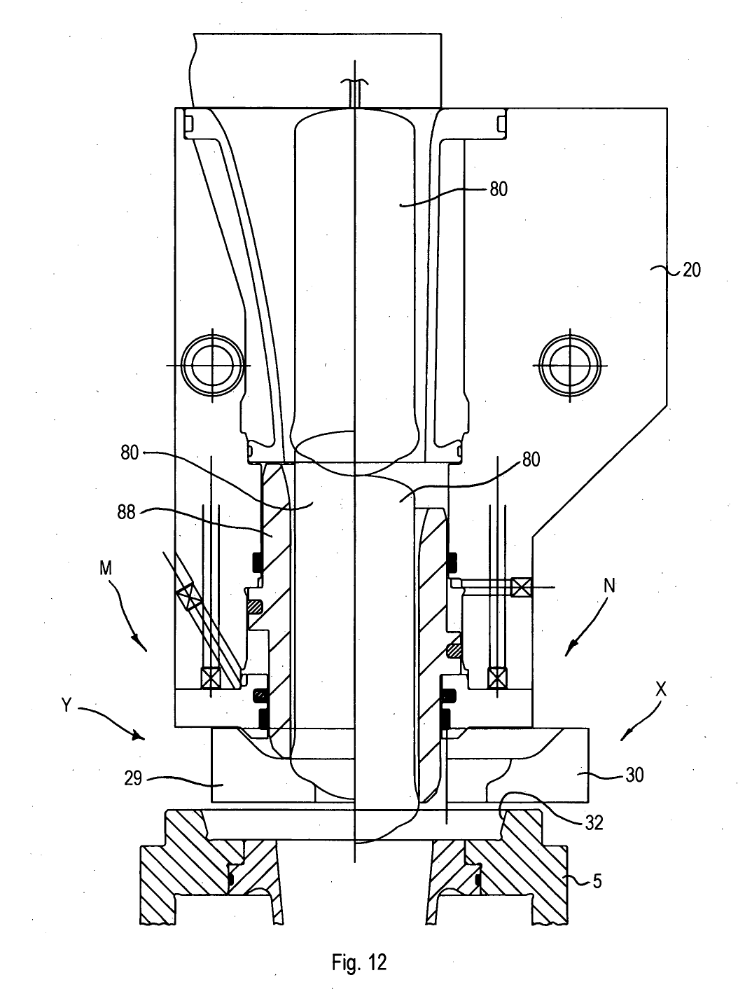

FIG. 12 is an enlarged detail of FIG. 11;

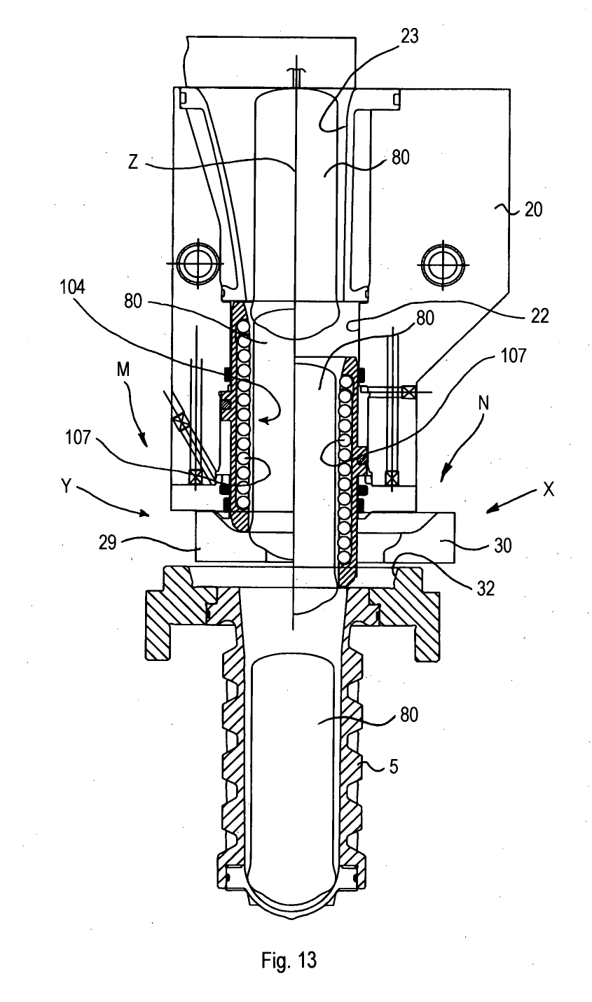

FIG. 13 is a section like the one in FIG. 5 that shows a fifth embodiment of a conveying element;

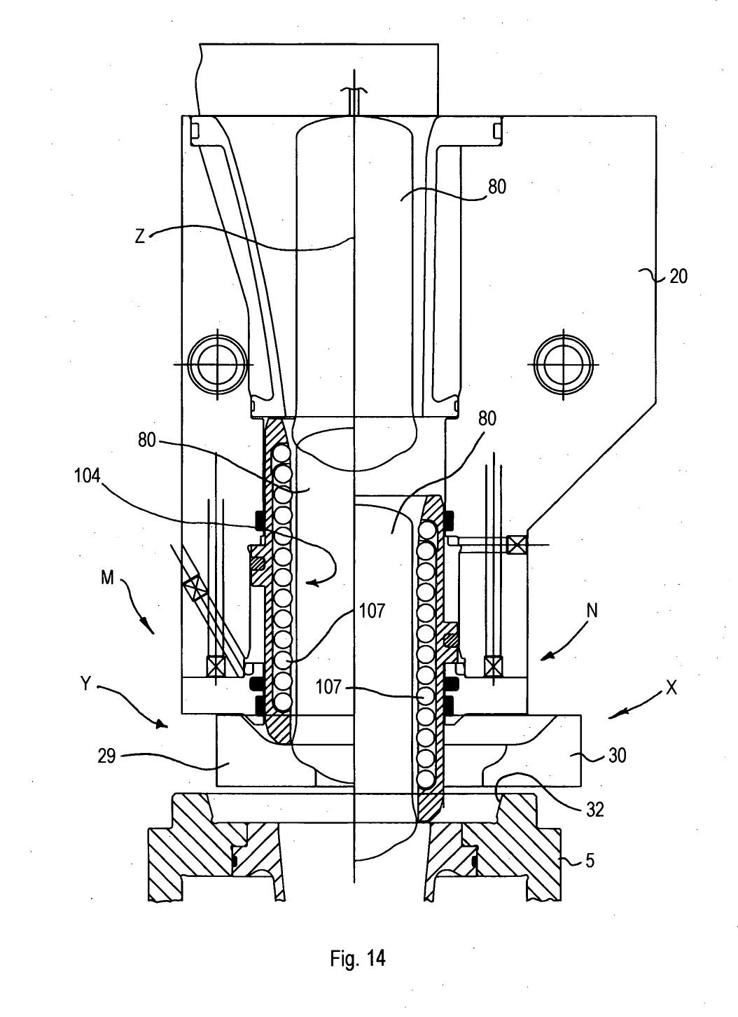

FIG. 14 is an enlarged detail of FIG. 13;

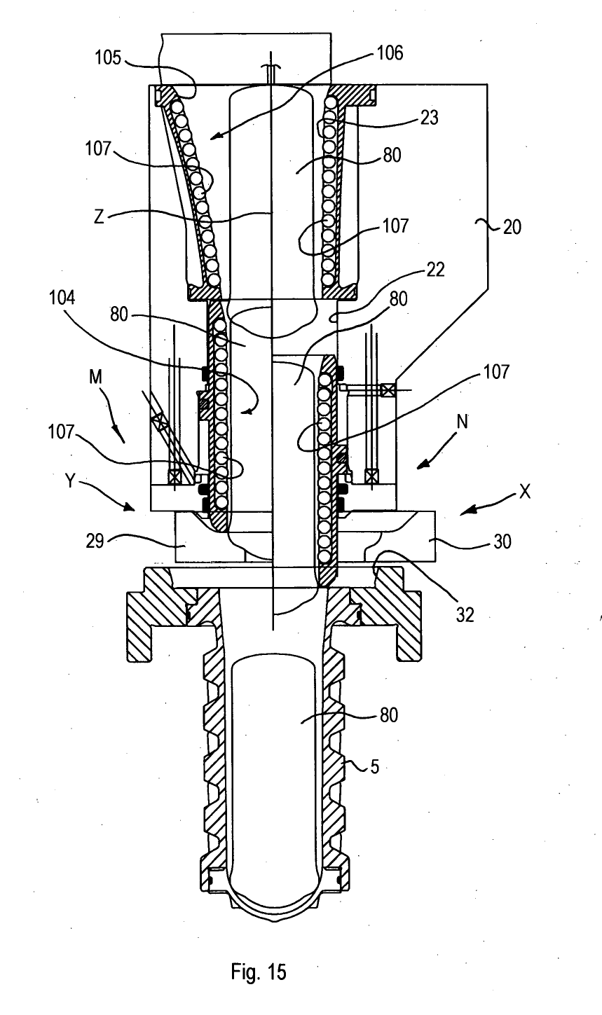

FIG. 15 is a section like the one in FIG. 5 that shows a sixth embodiment of a conveying element;

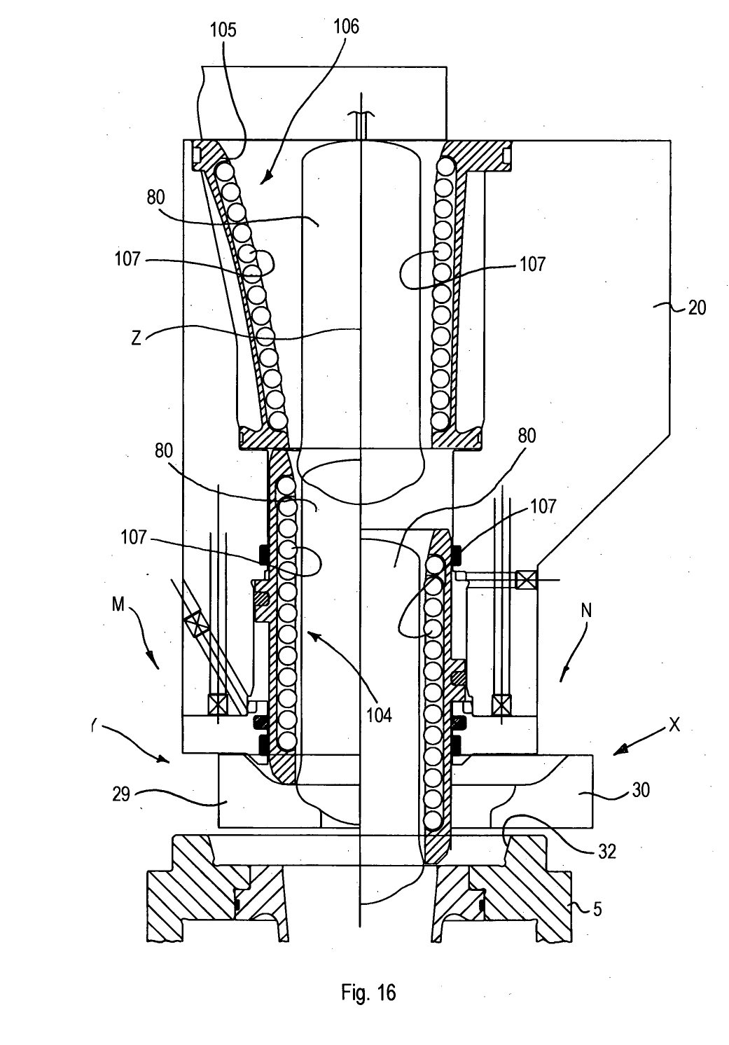

FIG. 16 is an enlarged detail of FIG. 15.

With reference to FIGS. 1 to 16, there is shown a forming device 1 for compression-moulding doses of plastic material comprising a carousel 2 that is rotatable around an axis A, in a direction R1, and supporting a plurality of forming moulds 3. The forming moulds 3 are positioned in a peripheral zone 4 of the carousel 2 and are arranged so as to be substantially angularly equidistant.

For the sake of simplicity, only some of the forming moulds 3 are shown in FIG. 1.

Each forming mould 3 comprises a mould cavity 5 (shown in FIGS. 5 to 16) and a punch—not shown—that are mutually movable. The forming mould 3 can assume an open configuration, in which the mould cavity 5 and the punch are mutually separated so that a dose 80 of plastic material is inserted inside the mould cavity 5 and a formed object, for example a container perform, is removed from the forming mould 3, and a closed configuration, in which the punch penetrates inside the mould cavity 5 to shape the dose 80.

In an embodiment that is not shown, the forming device 1 comprises, instead of the carousel 2, a moving and supporting element of the forming moulds 3 provided with a flexible element, for example a belt or chain element that is movable along a closed-loop path.

Cutting devices are also provided, which are not shown, that cut the plastic material that protrudes from a dispensing device of a plasticising device, for example an extruder, to give rise to the doses 80. The cutting devices may comprise one or several cutting elements and one or more contrasting elements that act as abutting means for the plastic material and prevent a cutting element, after a dose has been separated from the plastic material that exits the dispensing nozzle, from removing the dose from a delivering zone. There is further provided a conveying device 6 that receives the doses 80 that, the aforesaid cutting devices have separated from the dispensing nozzle and delivers the doses 80 to the forming device 1.

The conveying device 6 comprises a further carousel 7 rotatable around a further axis B, in a further direction R2, and supporting a plurality of conveying elements 8 positioned in a further peripheral zone 9 of the further carousel 7 and arranged so as to be substantially angularly equidistant.

The carousel 2 and the further carousel 7 can be rotated by driving devices—for example electric motors—that are independent and mutually synchronised.

In an embodiment that is not shown, the conveying device 6 comprises instead of the further carousel 7 a moving and supporting element of the conveying elements 8 provided with a flexible element, for example a belt or chain element that is movable along a closed-loop path.

Each conveying element 8 comprises a receiving element 21, arranged for receiving a dose 80 that the aforesaid cutting devices have separated from the dispensing nozzle, and a delivering element 20, arranged for delivering the dose 80 to a mould cavity 5.

The delivering element 20 comprises a containing portion 22, arranged for containing the dose 80 and for conferring on the dose 80 a desired shape and a connecting portion 23, interposed between the receiving element 21 and the containing portion 22 and arranged for promoting the transfer of the dose 80 from the receiving element 21 to the containing portion 22.

The receiving element 21 has a “C” or “U”, or “J” shape and is provided internally with a gap 24, that is open in the further rotating direction R2, and generally shaped as an upturned frustum of cone, i.e., having a section that decreases as it approaches the connecting portion 23.

The containing portion 22 is internally provided with a recess 25 with a substantially cylindrical shape.

The connecting portion 23 is internally provided with a further recess 26 shaped as an upturned frustum of cone, i.e. having a section that decreases as it approaches the containing portion 22. In other words, the connecting portion 23 is funnel-shaped for promoting the insertion of the dose 80 into the containing portion 22.

The delivering element 20 is provided, at the connecting portion 23, with an inlet opening 27 through which the dose 80, removed from the extruder (or from the aforesaid cutting devices that cut the plastic material that exits, a dispensing nozzle of the extruder to give rise to the doses 80) by the receiving element 21, penetrates inside the delivering element 20.

The delivering element 20 is provided, at the containing portion 22, with an outlet opening 28 through which the dose 80 is delivered to a mould cavity 5.

A first closing element 29 and a second closing element 30 are provided that are associated with the outlet opening 28 and are movable between an open configuration X, shown in the right part of FIGS. 5 to 16, in which the first closing element 29 and the second closing element 30 enable the passage of the dose 80 through the outlet opening 28, and a closed configuration Y, shown in the left part of FIGS. 5 to 16, in which the first closing element 29 and the second closing element 30 prevent the passage of the dose 80 through the outlet opening 28.

The first closing element 29 and the second closing element 30 comprise a shaped portion 31 arranged for disposing on the tip of the dose 80 a desired shape.

With reference to FIGS. 5 to 16, there is shown a delivering element 20 comprising a containing portion 22 provided with a guiding element 87 arranged for directing the dose 80 to the mould cavity 5.

The guiding element 87 comprises a sleeve 88 received inside the recess 25.

The guiding element 87 is movable between a retracted position M, shown in the left part of FIGS. 5 to 16, in which the sleeve 88 is contained inside the containing portion 22, and an extended position N, shown in the right part of FIGS. 5 to 16, in which the sleeve 88 projects through the outlet opening 28, possibly beyond the first closing element 29 and the second closing element 30, for delivering the dose 80 to the mould cavity 5.

In the embodiments of the conveying element 8 shown in FIGS. 5 to 8 and 13 to 16, when the guiding element 87 is in the extended, configuration N, an end portion of the sleeve 88 extends below an upper edge 32 of the mould cavity 5.

In the embodiments of the conveying element 8 shown in FIGS. 9 to 12, when the guiding element 87 is in the extended configuration N, an end portion of the sleeve 88 is maintained above the upper edge 32 of the mould cavity 5. The guiding element 87 assumes the retracted position M when the first closing element 29 and the second closing element 30 are in the closed configuration Y.

The guiding element 87 assumes the extended position N when the first closing element 29 and the second closing element 30 are in the open configuration X.

For ease of understanding, each of FIGS. 5 to 16 shows the same dose 80 in a plurality of successive positions. Further, as indicated above, each of FIGS. 5 to 16, for ease of understanding shows,—alongside one another, i.e. one on the right side and one on the left side—two distinct operating configurations of the guiding element 87. The guiding element 87 comprises an annular ridge 89 that leads away from the sleeve 88 to be received in a housing 91 obtained in the containing portion 22.

The annular ridge 89 comprises a first rib 92 and a second rib 93, that are spaced apart from one another, between which a groove 94 is defined that receives a sealing element 95 arranged for interacting with the housing 91.

The annular ridge 89 divides the housing 91 into a first chamber 96 and into a second chamber 97.

The first chamber 96 is supplied with an operating fluid, for example pressurised air, through a conduit 98.

The second chamber 97 is supplied with an operating fluid, for example pressurised air, through a further conduit 99.

In operation, when the guiding element 87 is in the retracted position M, the second chamber 97 is supplied with the operating fluid.

The annular ridge 89 is moved until the second rib 93 abuts, on an abutting surface 100 of the housing 91.

The guiding element 87 thus passes from the retracted position M to the extended position N.

Subsequently, the first chamber 96 is supplied with the operating fluid.

The annular ridge 89 is moved until the first rib 92 abuts on a further abutting surface 101 of the housing 91.

The operating fluid inside the second chamber 97 is evacuated through the further conduit 99.

The guiding element 87 returns, in this manner from the extended position N to the retracted position M.

The sleeve 88 comprises—i.e. is made at least in part of—a porous material.

The aforesaid material can be, for example, porous polytetrafluorethylene (PTFE).

The porous polytetrafluorethylene (PTFE) can have the following properties:
average dimensions of the pores from 20 to 100 micron;
percentage volume of the pores from 20% to 50%;
density from approximately 1.1 g/cm³ to approximately 1.6 g/cm³.

The porous polytetrafluorethylene (PTFE) is obtained by binding together microcapsules—in particular spherical microcapsules—of polytetrafluorethylene (PTFE). Between the mutually bound microcapsules there are empty spaces that bestow the desired porosity. The aforesaid empty spaces have a substantially uniform distribution in relation to the mass of polytetrafluorethylene (PTFE). With the porous, polytetrafluorethylene (PTFE) it is possible to obtain guiding elements 87 having walls that have low surface energy, such walls being highly hydrophobic. The aforesaid walls are thus very slidable and have a very small tendency to retain doses 80.

In order to obtain the porous polytetrafluorethylene (PTFE) binding resins are not necessary that alter the chemical composition thereof. This contributes to making porosity very uniform.

Through the pores of the porous material a fluid can be supplied, in particular a pressurised fluid, for example compressed air, that further hinders the adhesion of the doses 80 to the guiding element 87 as it forms a layer, or buffer; interposed between the doses 80 and the guiding element 87. The aforesaid fluid can be suitably cooled, to improve the anti-adhesive effect. If a pressurised fluid is used, when this fluid exits the pores of the porous material, it expands, decreasing the temperature thereof. This enables cooling of the doses 80 to be improved further. The aforesaid fluid can be the same operating fluid that moves the guiding element 87 from the retracted position M to the extended position N, and vice versa.

This enables very simple conveying elements 8 to be obtained inasmuch as the fluid intended to exit the pores of the porous material does not require dedicated supplying conduits.

Alternatively, the fluid intended to exit the pores of the porous material can be supplied to the guiding element 87 by dedicated supplying conduits.

The porous polytetrafluorethylene (PTFE) is shaped so that the pores can be traversed by the gases, for example air, but cannot be traversed by liquids, for example water, having a pressure lower than a preset value.

It is thus possible to provide a “mixed” cooling system i.e. a cooling system in which some parts of the guiding element 87 are in contact with a low-pressure cooling system (for example 0.1-0.3 bar) and further parts of the guiding element 87 are also traversed by a cooling gas.

With reference to FIGS. 7 and 8 and to FIGS. 11 and 12, two embodiments of the conveying element 8 are shown in which the sleeve 88 is integrally made of porous material. With reference to FIGS. 5 and 6 and to FIGS. 9 and 10, two embodiments of the conveying element 8 are shown in which the sleeve 88 comprises an internal tubular element 102, intended for interacting with the doses 80, made of porous material and an external tubular element. 103, intended for receiving and surrounding at least partially the internal tubular element 102, made of non-porous material, for example of metal. The external tubular element 103 can be traversed by conduits arranged for supplying a cooling fluid that cools the external tubular element 103. The fluid intended for exiting the pores of the porous material that forms the internal tubular element 102 can be the same operating fluid that moves the guiding element 87 from the retracted position M to the extended position N, and vice versa. In this case, in the external tubular element 103 openings can be provided that enable the passage of the aforesaid fluid.

Alternatively, the fluid intended for exiting the pores of the porous material that forms the internal tubular element 102 can be supplied to the guiding element 87 through dedicated supplying conduits.

With reference to FIGS. 13 and 14, there is shown an embodiment of the conveying element 8 in which the sleeve 88 rotatably supports rolling means 104.

In this embodiment, the sleeve 88 is made completely of porous material, as in the embodiments of the conveying element 8 shown in FIGS. 7 and 8 and in FIGS. 11 and 12. The rolling means 104 can also be provided in the embodiments of the tubular element 8 shown in FIGS. 5 and 6 and in FIGS. 9 and 10, i.e. in the embodiments of the conveying element 8 that provide for the sleeve 88 comprising the internal tubular element 102 made of porous material and the external tubular element 103 made of non-porous material. In this way, the rolling means 104 is rotatably supported by the internal tubular element 102.

With reference to FIGS. 15 and 16, there is shown an embodiment of the conveying element 8 in which an internal wall 105 of the receiving portion 21 rotatably supports further rolling means 106.

The rolling means 104 and the further rolling means 106 enables the dose 80 to be guided that is inside the containing portion 22 or, respectively, the connecting portion 23 in a precise manner, which reduces the risk that the dose 80 is tilted whilst it is conveyed from the delivering element 20. In this manner the impacts between the dose 80 and the internal surface of the delivering element 20 are reduced. The dose 80 is maintained aligned along a desired direction and can be introduced more easily into the mould cavities 5.

The contact between the dose 80 and the delivering element 20 occurs on restricted zones of the rolling means 104 and of the further rolling means 106 in which a rolling friction develops. Owing to this, the dose 80 can move inside the delivering element 20 at a rather high speed.

The rolling means 104 and the further rolling means 106 comprise rollers 107 that define a plurality of rows extending along a longitudinal axis Z of the delivering element 20.

The rollers 107 have rotating axes that lie on transversely arranged planes—in particular arranged substantially perpendicularly—with respect to the longitudinal axis Z. The rollers 107 positioned at the same vertical height define a polygon having a number of sides corresponding to the number of the aforesaid rows.

The rollers 107 can occupy substantially entirely the internal surfaces of the sleeve 88 and of the connecting portion 23.

In an embodiment, the rollers 107 can be hollow, so that they can be filled with substances that increase the heat-exchanging properties thereof. In this manner, the rollers 107 are able to dissipate the heat transmitted by the dose 80 more easily.

In another embodiment, the rollers 107 can be made of a material having great thermal conductivity (for example rollers 107 made of aluminium can be provided).

The rollers 107 can have a suitably selected surface finish so as to ensure that the rollers have a low friction coefficient. In particular the rollers 107 may have a glazed external surface. This enables the adhesion of the plastic material to the rollers 107 to be reduced.

The rolling means 104 is cooled by the fluid that exits the pores of the material that forms the entire sleeve 88, or the internal tubular element 102.

Further, the aforesaid fluid generates a layer that limits the adhesion of the plastic material that forms the dose 80 to the rolling means 104.

The further rolling means 106 can be cooled by a fluid that circulates in conduits obtained in the connecting portion 23.

In the embodiments of the conveying element 8 shown in FIGS. 5 to 16 the entire delivering element 20—i.e., in particular, also the connecting portion 23—can be made of porous material.

In this case, the further rolling means 106 is cooled by the fluid that exits the pores of the material that forms the connecting portion 23.

Further, the aforesaid fluid generates a layer that limits the adhesion of the plastic material that forms the dose 80 to the further rolling means 106.

In an embodiment that is not shown, a wall of the receiving element 21 that bounds the gap 24 can rotatably support still further rolling means. The still further rolling means limits the friction between the doses 80 and the receiving element and guides the doses 80 whilst the latter traverse the receiving element.

The still further rolling means can comprise rollers shaped and positioned similarly to what has been disclosed with reference to the rollers 107.

1-45. (canceled)

46. Apparatus for transferring doses of material, comprising a transferring arrangement arranged for delivering doses of synthetic plastic material to a compression-molding device, said transferring arrangement comprising a containing arrangement arranged for receiving said doses, wherein said transferring arrangement comprises a movement-promoting arrangement received in said containing arrangement and movable with respect to said containing arrangement for delivering said doses to said compression-molding device, said movement-promoting arrangement being made at least partially of a porous material; and rolling elements rotably supported on said movement-promoting arrangement and arranged for interacting with said doses.

47. Apparatus according to claim 46, wherein said porous material comprises porous polytetrafluorethylene (PTFE).

48. Apparatus according to claim 46, and further comprising a supply device arranged for supplying a fluid inside said containing arrangement through pores of said porous material.

49. Apparatus according to claim 46, wherein said movement-promoting arrangement comprises a sleeve.

50. Apparatus according to claim 49, wherein said sleeve comprises an internal tubular element made of said porous material and an external tubular element made of a non-porous material.

51. Apparatus according to claim 46, wherein said rolling elements comprise rollers that define a plurality of rows extending along a longitudinal axis of said containing arrangement; said rollers having rotation axes that lie on planes arranged transversely with respect to said longitudinal axis.

52. Apparatus according to claim 46, wherein said rolling elements comprise rollers that occupy substantially entirely an internal surface of said movement-promoting arrangement.

53. Apparatus according to claim 46, wherein said containing arrangement is provided with an internal recess having a substantially cylindrical shape.

54. Apparatus according to claim 46, wherein said containing arrangement is made of said porous material.

55. Apparatus according to claim 46, wherein said containing arrangement is made of a non-porous material.

56. Apparatus according to claim 46, wherein said transferring arrangement comprises a connecting portion arranged for receiving said doses and delivering said doses to said containing arrangement.

57. Apparatus according to claim 56, wherein said connecting portion is made of said porous material.

58. Apparatus according to claim 56, wherein an internal wall of said connecting portion rotatably supports further rolling elements intended for interacting with said doses.

59. Apparatus according to claim 46, and further comprising a carousel arrangement rotatable around a further rotation axis and supporting said transferring arrangement, and a flexible movement element supporting said transferring arrangement.

60. Apparatus according to claim 46, wherein said compression-molding device comprises one of a carousel that is rotatable around a rotation axis and supports a plurality of molds and a flexible movement element supporting a plurality of molds.
